(19) United States
(12) Patent Application Publication
(10) Pub. No.: US 2019/0215767 A1
(43) Pub. Date: Jul. 11, 2019

(54) SYSTEMS AND METHODS FOR NOTIFICATION WITH REDUCED POWER CONSUMPTION AND INCREASED ACCURACY

(71) Applicant: QUALCOMM Incorporated, San Diego, CA (US)

(72) Inventors: Alan Soloway, Erie, CO (US); Carlos Marcelo Dias Pazos, Carlsbad, CA (US); Nagaraju Naik, San Diego, CA (US)

(21) Appl. No.: 16/208,729

(22) Filed: Dec. 4, 2018

Related U.S. Application Data
(60) Provisional application No. 62/614,100, filed on Jan. 5, 2018.

(51) Int. Cl. H04W 52/02; H04W 4/20; H04W 4/38; H04W 4/70

(52) U.S. Cl. CPC H04W 52/0216; H04W 4/70; H04W 4/38; H04W 4/20

(57) ABSTRACT

A client device may receive one or more defined parameters comprising one or more parameters that indicate a first time window in which the client device must notify a server device regarding one or more values detected by the client device; one or more parameters that indicate one or more conditions that, if satisfied, the client device must notify the server device regarding the one or more values detected by the client device; and one or more parameters that indicate a second time window, which overlaps the first time window, in which the client device must evaluate the one or more conditions to determine whether the one or more conditions are satisfied. The client device may modify a configuration of the client device to, based on the received one or more defined parameters, notify the server device regarding at least one value detected by the client device.

### CROSS-REFERENCE TO RELATED APPLICATIONS

This application claims priority to and the benefit of U.S. provisional patent application Ser. No. 62/614,100, entitled “NOTIFICATION SYSTEMS AND METHODS” and filed Jan. 5, 2018, the disclosure of which is incorporated by reference herein it its entirety.

### BACKGROUND

The present disclosure relates generally to communication systems, and more particularly, to providing and receiving notifications with reduced power consumption and increased accuracy.

Machine to machine (M2M) is a broad label that can be used to describe any technology that enables networked devices to exchange information and perform actions without the manual assistance of humans.

In some instances, a first M2M device may be a client device and a second M2M device may be a server device, for example, LwM2M Devices as discussed in Lightweight Machine to Machine Technical Specification, approved version 1.0.1, Open Mobile Alliance, Jul. 4, 2017.

The M2M client device may be configured to detect one or more values (e.g., a temperature measured by a temperature sensor) and notify the M2M server device regarding the one or more values detected by the M2M client device. The M2M server device may perform one or more actions in response to the notification, which may include automatically performing one or more other actions (e.g., automatically notifying a human or other actions).

Some M2M client devices, which are intended to notify an M2M server device regarding one or more values detected by the M2M client device for long periods of time, may have a limited power supply. Consequently, it can be difficult for such M2M client devices to effectively notify the M2M server device without also inefficiently depleting the M2M client devices' limited power supplies.

### SUMMARY

A need therefore exists for systems and methods that eliminate or reduce the disadvantages and problems listed above and/or other disadvantages and problems.

One aspect is a method for providing notifications. The method may comprise, by a client device, receiving one or more defined parameters. The one or more defined parameters may comprise one or more parameters that indicate a first time window in which the client device must notify a server device regarding one or more values detected by the client device; one or more parameters that indicate one or more conditions that, if satisfied, the client device must notify the server device regarding the one or more values detected by the client device; and one or more parameters that indicate a second time window, which overlaps the first time window, in which the client device must evaluate the one or more conditions to determine whether the one or more conditions are satisfied. The method may also comprise, by the client device, modifying a configuration of the client device to, based on the received one or more defined parameters, notify the server device regarding at least one value detected by the client device. The method may also comprise, by the client device, based on the modified configuration of the client device, notifying the server device regarding the at least one value detected by the client device. The client device may receive the one or more defined parameters from the server device.

Another aspect is an apparatus for providing notifications. The apparatus may comprise one or more processors configured with processor-executable instructions to perform operations. The operations may comprise, by a client device, receiving one or more defined parameters. The one or more defined parameters may comprise one or more parameters that indicate a first time window in which the client device must notify a server device regarding one or more values detected by the client device; one or more parameters that indicate one or more conditions that, if satisfied, the client device must notify the server device regarding the one or more values detected by the client device; and one or more parameters that indicate a second time window, which overlaps the first time window, in which the client device must evaluate the one or more conditions to determine whether the one or more conditions are satisfied. The operations may also comprise, by the client device, modifying a configuration of the client device to, based on the received one or more defined parameters, notify the server device regarding at least one value detected by the client device. The operations may also comprise, by the client device, based on the modified configuration of the client device, notifying the server device regarding the at least one value detected by the client device. The client device may receive the one or more defined parameters from the server device.

Yet another aspect is a method for obtaining notifications. The method may comprise, by a server device, sending, to a client device, one or more defined parameters. The one or more defined parameters may comprise one or more parameters that indicate a first time window in which the client device must notify the server device regarding one or more values detected by the client device; one or more parameters that indicate one or more conditions that, if satisfied, the client device must notify the server device regarding the one or more values detected by the client device; and one or more parameters that indicate a second time window, which overlaps the first time window, in which the client device must evaluate the one or more conditions to determine whether the one or more conditions are satisfied. The client device may be configured to (1) receive the one or more defined parameters sent by the server device, (2) modify a configuration of the client device to, based on the received one or more defined parameters, notify the server device regarding at least one value detected by the client device and (3) based on the modified configuration of the client device, notify the server device regarding the at least one value detected by the client device. The method may also comprise, by the server device, receiving, from the client device, the notification regarding the at least one value detected by the client device.

Still another aspect is an apparatus for obtaining notifications. The apparatus may comprise one or more processors configured with processor-executable instructions to perform operations. The operations may comprise, by a server device, sending, to a client device, one or more defined parameters. The one or more defined parameters may comprise one or more parameters that indicate a first time window in which the client device must notify the server device regarding one or more values detected by the client device; one or more parameters that indicate one or more conditions that, if satisfied, the client device must notify the server device regarding the one or more values detected by the client device; and one or more parameters that indicate a second time window, which overlaps the first time window, in which the client device must evaluate the one or more conditions to determine whether the one or more conditions are satisfied. The client device may be configured to (1) receive the one or more defined parameters sent by the server device, (2) modify a configuration of the client device to, based on the received one or more defined parameters, notify the server device regarding at least one value detected by the client device and (3) based on the modified configuration of the client device, notify the server device regarding the at least one value detected by the client device. The operations may also comprise, by the server device, receiving, from the client device, the notification regarding the at least one value detected by the client device.

For purposes of summarizing, some aspects, advantages and features of a few of the embodiments of the invention have been described in this summary. Some embodiments of the invention may include some or all of these summarized aspects, advantages and features. However, not necessarily all of (or any of) these summarized aspects, advantages or features will be embodied in any particular embodiment of the invention. Thus, none of these summarized aspects, advantages and features are essential. Some of these summarized aspects, advantages and features and other aspects, advantages and features may become more fully apparent from the following detailed description and the appended claims.

### BRIEF DESCRIPTION OF THE DRAWINGS

The appended drawings contain figures of preferred embodiments to further clarify the above and other aspects, advantages and features. It will be appreciated that these drawings depict only preferred embodiments of the invention and are not intended to limit its scope. These preferred embodiments will be described and explained with additional specificity and detail through the use of the accompanying drawings in which:

FIG. 1 is a flowchart illustrating embodiment methods for providing and/or obtaining notifications;

FIG. 2 is a diagram illustrating an embodiment set of parameters for providing notifications;

FIG. 3 is a flowchart illustrating an embodiment method for providing notifications;

FIG. 4 is a flowchart illustrating an embodiment method for providing notifications;

FIGS. 5A and 5B are diagrams illustrating an embodiment timeline for providing notifications;

FIGS. 6A, 6B and 6C are diagrams illustrating an embodiment timeline for providing notifications;

FIGS. 7A, 7B, 7C, 7D, 7E and 7F are diagrams illustrating an embodiment timeline for providing notifications; and

FIG. 8 is a diagram illustrating an embodiment computing device.

### DETAILED DESCRIPTION

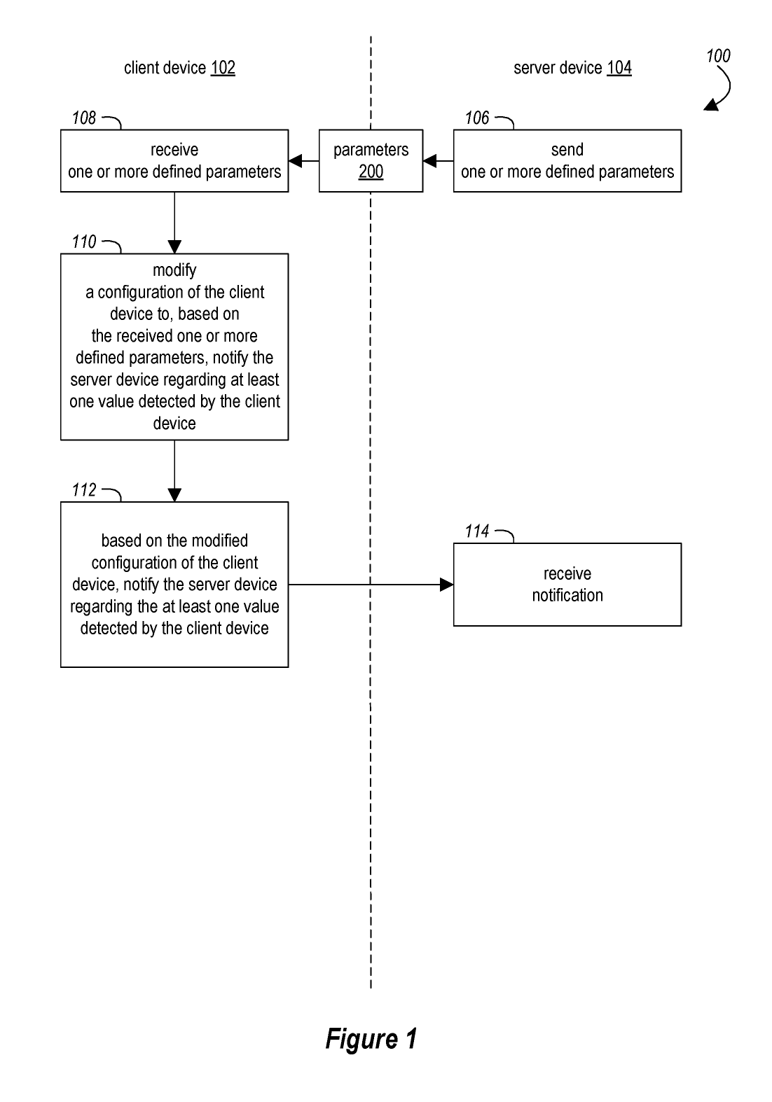

Referring to FIG. 1, a communication system may include a first, client device 102 and a second, server device 104. In some embodiments, the client device 102 and the server device 104 may be M2M devices, for example, LwM2M Devices as discussed in Lightweight Machine to Machine Technical Specification, approved version 1.0.1, Open Mobile Alliance, Jul. 4, 2017, the disclosure of which is incorporated by reference herein in its entirety. In some embodiments, the client device 102 and the server device 104 may be physically separate and distinct devices. In some embodiments, a single computing device may comprise both the client device 102 and the server device 104.

In some embodiments, the communication system that includes the client device 102 and the server device 104 may comprise a wireless communication system. Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, e.g., a Long Term Evolution (LTE) system or a New Radio (NR) system. A wireless multiple-access communication system may include a number of base stations or access network nodes, each simultaneously supporting communication for multiple communication devices, which may be otherwise known as user equipment (UE). In some embodiments, the client device 102 may be a user equipment, the server device 104 may be a user equipment, or both the client device 102 and the server device 104 may be a user equipment.

The client device 102 and the server device 104 may communicate using one or more wireless communication systems (such as, CDMA systems, TDMA systems, OFDMA systems, LTE systems, NR systems, WiFi systems, Bluetooth systems, or any wireless communication systems), one or more wired communication systems, or any combination thereof. Thus, in some embodiments, the client device 102 and the server device 104 may communicate using one or more wireless links, one or more wired links, or any combination thereof.

The client device 102 may be configured to detect one or more values, for example, one or more measurements (e.g., a temperature measured by a temperature sensor, a pressure measured by a pressure sensor, a utility meter measurement such as from an electricity meter or a natural gas meter, a quality-of-service measurement such as downlink bandwidth performance or radio signal strength, medical-related measurements such as a patient's pulse rate or blood pressure, or any other suitable measurements), one or more other detectable values, or any combination thereof.

The client device 102 may be configured to notify the server device 104 regarding at least one value detected by the client device 102. For example, in some embodiments, to notify the server device 104 regarding at least one value detected by the client device 102, the client device 102 may send the at least one value detected by the client device 102 to the server device 104.

The client device 102 may be configured to notify the server device 104 regarding at least one value detected by the client device 102 based on one or more defined parameters 200. The one or more defined parameters 200 may include (1) one or more parameters that indicate a first time window in which the client device 102 must notify the server device 104 regarding one or more values detected by the client device 102; (2) one or more parameters that indicate one or more conditions that, if satisfied, the client device 102 must notify the server device 104 regarding the one or more values detected by the client device 102; (3) one or more other parameters; or any combination thereof.

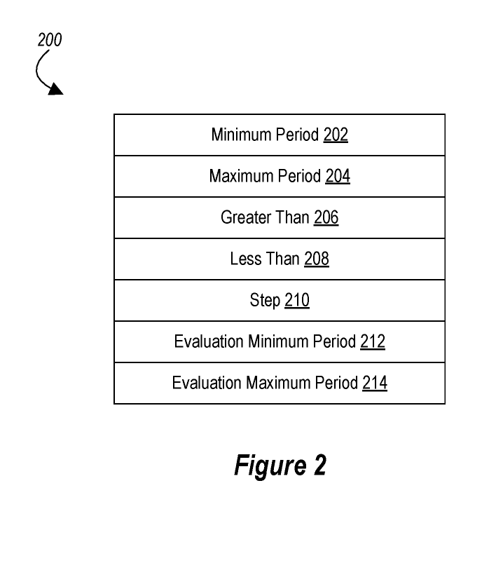

In some embodiments, the one or more parameters that indicate a first time window in which client device 102 must notify the server device 104 regarding one or more values detected by the client device 102 may include (1) a parameter 202 in FIG. 2 that indicates a minimum time the client device 102 must wait between two adjacent notifications to the server device 104, such as, for example, the Minimum Period <NOTIFICATION> Class Attribute as defined in Lightweight Machine to Machine Technical Specification, approved version 1.0.1, Open Mobile Alliance, Jul. 4, 2017; (2) a parameter 204 in FIG. 2 that indicates a maximum time the client device 102 may wait between two adjacent notifications to the server device 104, such as, for example, the Maximum Period <NOTIFICATION> Class Attribute as defined in Lightweight Machine to Machine Technical Specification, approved version 1.0.1, Open Mobile Alliance, Jul. 4, 2017; (3) one or more other parameters that indicate the first time window, such as, a start time, a stop time, a length of time, and/or any other suitable parameter; or any combination thereof.

In some embodiments, the one or more parameters that indicate one or more conditions that, if satisfied, the client device 102 must notify the server device 104 may include one or more parameters that indicate that the client device 102 must notify the server device 104 if a value detected by the client device 102 satisfies a threshold.

The one or more parameters that indicate that the client device 102 must notify the server device 104 if a value detected by the client device 102 satisfies a threshold may include (1) a parameter 206 in FIG. 2 that indicates that the client device 102 must notify the server device 104 if a value detected by the client device 102 is greater than a threshold value, such as, for example, the Greater Than <NOTIFICATION> Class Attribute as defined in Lightweight Machine to Machine Technical Specification, approved version 1.0.1, Open Mobile Alliance, Jul. 4, 2017; (2) a parameter 208 in FIG. 2 that indicates that the client device 102 must notify the server device 104 if a value detected by the client device 102 is less than a threshold value, such as, for example, the Less Than <NOTIFICATION> Class Attribute as defined in Lightweight Machine to Machine Technical Specification, approved version 1.0.1, Open Mobile Alliance, Jul. 4, 2017; (3) a parameter 210 in FIG. 2 that indicates that the client device 102 must notify the server device 104 if a value detected by the client device 102 varies a threshold amount relative to a previous value of which the client device 102 last notified the server device 104, such as, for example, the Step <NOTIFICATION> Class Attribute as defined in Lightweight Machine to Machine Technical Specification, approved version 1.0.1, Open Mobile Alliance, Jul. 4, 2017; (4) a parameter that indicates that the client device 102 must notify the server device 104 if a value detected by the client device 102 is greater than or equal to a threshold value; (5) a parameter that indicates that the client device 102 must notify the server device 104 if a value detected by the client device 102 is less than or equal to a threshold value; (6) a parameter that indicates that the client device 102 must notify the server device 104 if a value detected by the client device 102 is equal to a threshold value; (7) a parameter that indicates that the client device 102 must notify the server device 104 if a value detected by the client device 102 is within a range of values; (8) one or more other parameters that indicate that the client device 102 must notify the server device 104 if a value detected by the client device 102 satisfies a threshold; or any combination thereof.

In some embodiments, the client device 102 may receive the one or more defined parameters 200; may modify a configuration of the client device 102 to, based on the received one or more defined parameters, notify the server device 104 regarding at least one value detected by the client device 102; and may, based on the modified configuration of the client device 102, notify the server device 104 regarding the at least one value detected by the client device 102.

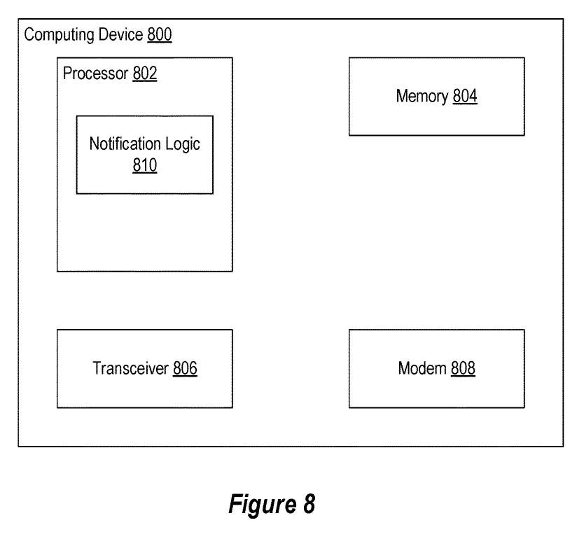

In further detail, FIG. 1 illustrates methods 100 for providing and/or obtaining notifications according to some embodiments, which may be performed by one or more processors of one or more computing devices—such as one or more processors 802 (FIG. 8) that may be configured with notification logic 810 which performs the methods 100, performs other functionality (including other functionality described herein), or performs any combination thereof. As shown in FIG. 1, the methods 100 may include one or more blocks, such as block 106, block 108, block 110, block 112, block 114, one or more other blocks, or any combination thereof.

At block 108, the client device 102 may receive one or more defined parameters, such as, the one or more defined parameters 200. In some embodiments, at block 106, the server device 104 may send the one or more defined parameters to the client device 102 via a defined interface, such as, for example, by sending a Write-Attributes command that includes the one or more defined parameters via the Device Management and Service Enablement interface as defined in Lightweight Machine to Machine Technical Specification, approved version 1.0.1, Open Mobile Alliance, Jul. 4, 2017. In such embodiments, at block 108, the client device may receive the one or more defined parameters from the server device 104 via the defined interface, such as, for example, by receiving a Write-Attributes command that includes the one or more defined parameters via the Device Management and Service Enablement interface as defined in Lightweight Machine to Machine Technical Specification, approved version 1.0.1, Open Mobile Alliance, Jul. 4, 2017.

At block 110, the client device 102 may modify a configuration of the client device 102 to, based on the received one or more defined parameters, notify the server device 104 regarding at least one value detected by the client device 102. In some embodiments, at block 110, the client device 102 may modify the configuration of the client device 102 by performing a Write-Attributes operation as defined in Lightweight Machine to Machine Technical Specification, approved version 1.0.1, Open Mobile Alliance, Jul. 4, 2017.

At block 112, the client device 102 may, based on the modified configuration of the client device 102, notify the server device 104 regarding the at least one value detected by the client device 102. In some embodiments, to notify the server device 104 regarding at least one value detected by the client device 102 at block 112, the client device 102 may send the at least one value detected by the client device 102 to the server device 104, for example, by performing a Notify operation as defined in Lightweight Machine to Machine Technical Specification, approved version 1.0.1, Open Mobile Alliance, Jul. 4, 2017.

At block 114, the server device 104 may receive the notification from the client device 102. In some embodiments, at block 114, the notification may include the at least one value detected by the client device 102, for example, when the client device 102 performs a Notify operation as defined in Lightweight Machine to Machine Technical Specification, approved version 1.0.1, Open Mobile Alliance, Jul. 4, 2017.

Applicants have observed that—where the one or more defined parameters 200 include (1) one or more parameters that indicate a first time window in which a client device must notify a server device and (2) one or more parameters that indicate one or more conditions that, if satisfied, the client device must notify the server device—the client device might wait until the end of the first time window to notify the server device and/or wait until the end of the first time window to evaluate whether the one or more conditions are satisfied. In particular, Applicants have observed that a client device that is configured to go into and out of a low power state—such as, LTE Power Saving Mode (PSM)—may go into the lower power state until the end of the first time window, wake up from the low power state, evaluate whether the one or more conditions are satisfied, notify the service device based on the one or more parameters (e.g., based on the first time window, based on the one or more conditions, or both), and return to the low power state. Applicants have further observed that the one or more conditions could be temporarily satisfied while the client device was in the low power state (and thus while the client device was not attempting to evaluate whether the one or more conditions were satisfied) but no longer satisfied by the time when the client device woke up from the lower power state, which would disadvantageously prevent the server device from being notified that the one or more conditions had been satisfied.

As will be apparent from the discussion below, to address this disadvantage and/or other disadvantages, the one or more defined parameters 200 may advantageously include one or more parameters that indicate a second time window, which overlaps (e.g., is at least partially within or is completely within) the first time window, in which the client device 102 must evaluate the one or more conditions to determine whether the one or more conditions are satisfied.

In some embodiments, the one or more parameters that indicate a second time window, which overlaps the first time window, in which the client device 102 must evaluate the one or more conditions to determine whether the one or more conditions are satisfied may include (1) a parameter that indicates a maximum time the client device may wait between two adjacent evaluations of the one or more conditions made in the first time window; (2) a parameter that indicates a minimum time the client device must wait between two adjacent evaluations of the one or more conditions made in the first time window; (3) a parameter that indicates a maximum time from the start of the first time window the client device may wait to evaluate the one or more conditions; (4) a parameter that indicates a minimum time from the start of the first time window the client device must wait to evaluate the one or more conditions; (5) a parameter that indicates a maximum time the client device may wait between two adjacent evaluations of the one or more conditions, e.g., two adjacent evaluations made in the first time window or two adjacent evaluations including a first evaluation made before the first time window and a second evaluation made in the first time window; (6) a parameter that indicates a minimum time the client device must wait between two adjacent evaluations of the one or more conditions, e.g., two adjacent evaluations made in the first time window or two adjacent evaluations including a first evaluation made before the first time window and a second evaluation made in the first time window; (7) one or more other parameters that indicate the second time window, such as, a start time, a stop time, a length of time, and/or any other suitable parameter; or any combination thereof. If desired, in some embodiments, various technologies (such as, the <NOTIFICATION> Class Attribute in Lightweight Machine to Machine Technical Specification, approved version 1.0.1, Open Mobile Alliance, Jul. 4, 2017) may be modified to add the one or more parameters that indicate the second time window.

In some embodiments, a parameter 212 (FIG. 2) may be a parameter that indicates a minimum time the client device must wait between two adjacent evaluations of the one or more conditions made in the first time window, a parameter that indicates a minimum time the client device must wait between two adjacent evaluations of the one or more conditions (e.g., both evaluations made in the first time window or one evaluation made before the first time window and one evaluation made in the first time window), a parameter that indicates a minimum time from the start of the first time window the client device must wait to evaluate the one or more conditions, or any combination thereof depending, for example, upon the particular embodiment. Thus, in some embodiments for example, a single parameter may indicate both (1) a minimum time the client device must wait between two adjacent evaluations of the one or more conditions made in the first time window and (2) a minimum time from the start of the first time window the client device must wait to evaluate the one or more conditions. However, if desired, in some embodiments, a first parameter may indicate a minimum time the client device must wait between two adjacent evaluations of the one or more conditions made in the first time window, while a separate and distinct second parameter may indicate a minimum time from the start of the first time window the client device must wait to evaluate the one or more conditions.

In some embodiments, a parameter 214 (FIG. 2) may be a parameter that indicates a maximum time the client device may wait between two adjacent evaluations of the one or more conditions made in the first time window, a parameter that indicates a maximum time the client device may wait between two adjacent evaluations of the one or more conditions (e.g., both evaluations made in the first time window or one evaluation made before the first time window and one evaluation made in the first time window), a parameter that indicates a maximum time from the start of the first time window the client device may wait to evaluate the one or more conditions, or any combination thereof depending, for example, upon the particular embodiment. Thus, in some embodiments for example, a single parameter may indicate both (1) a maximum time the client device may wait between two adjacent evaluations of the one or more conditions made in the first time window and (2) a maximum time from the start of the first time window the client device may wait to evaluate the one or more conditions. However, if desired, in some embodiments, a first parameter may indicate a maximum time the client device may wait between two adjacent evaluations of the one or more conditions made in the first time window, while a separate and distinct second parameter may indicate a maximum time from the start of the first time window the client device may wait to evaluate the one or more conditions.

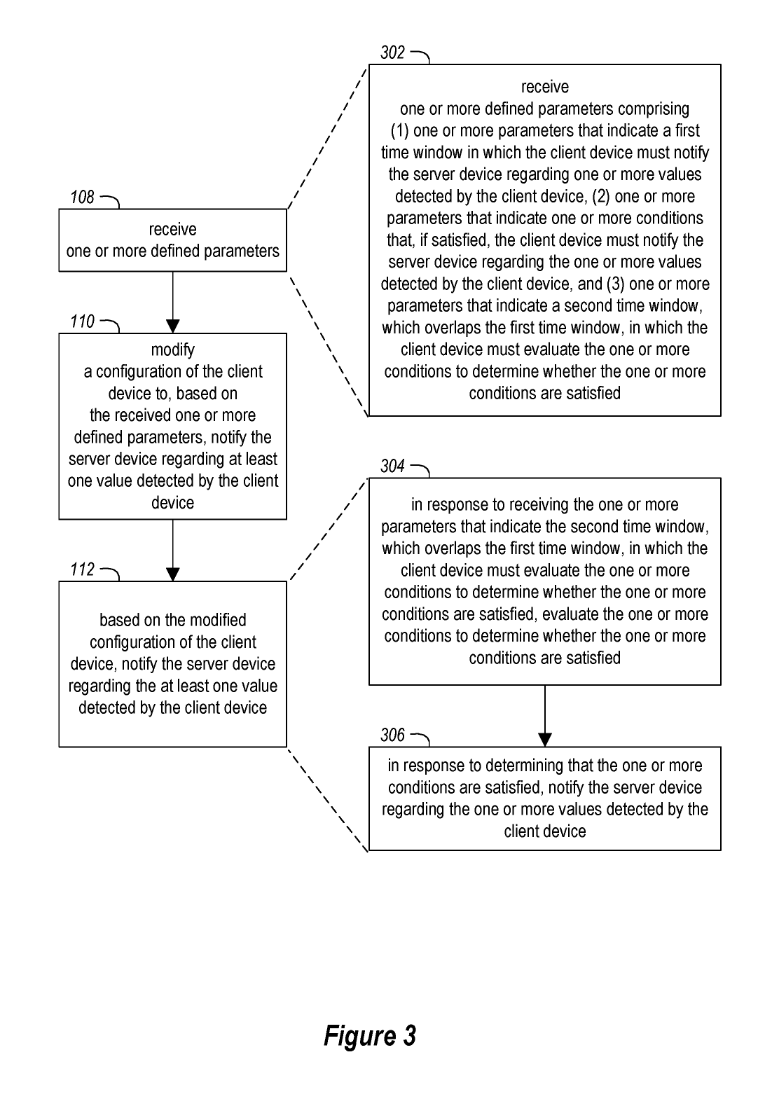

As shown in FIG. 3, in some embodiments, block 108 (FIG. 1) may include one or more blocks, such as, block 302, which may be performed by one or more processors of one or more computing devices—such as one or more processors 802 (FIG. 8) that may be configured with notification logic 810 which performs block 302, performs other functionality (including other functionality described herein), or performs any combination thereof.

In further detail, as shown above, the one or more defined parameters 200 may include (1) one or more parameters that indicate a first time window in which the client device 102 must notify the server device 104 regarding one or more values detected by the client device 102, (2) one or more parameters that indicate one or more conditions that, if satisfied, the client device 102 must notify the server device 104 regarding the one or more values detected by the client device 102, and (3) one or more parameters that indicate a second time window, which overlaps the first time window, in which the client device 102 must evaluate the one or more conditions to determine whether the one or more conditions are satisfied.

Thus, at block 302, the client device 102 may receive one or more defined parameters (such as, the one or more defined parameters 200) comprising (1) one or more parameters that indicate a first time window in which the client device 102 must notify the server device 104 regarding one or more values detected by the client device 102; (2) one or more parameters that indicate one or more conditions that, if satisfied, the client device 102 must notify the server device 104 regarding the one or more values detected by the client device 102; (3) one or more parameters that indicate a second time window, which overlaps the first time window, in which the client device 102 must evaluate the one or more conditions to determine whether the one or more conditions are satisfied; (4) one or more other parameters; or any combination thereof.

As shown in FIG. 3, in some embodiments, block 112 (FIG. 1) may include one or more blocks, such as, blocks 304 and 306, which may be performed by one or more processors of one or more computing devices—such as one or more processors 802 (FIG. 8) that may be configured with notification logic 810 which performs blocks 304 and 306, performs other functionality (including other functionality described herein), or performs any combination thereof.

At block 304, the client device 102 may—in response to receiving the one or more parameters that indicate the second time window, which overlaps the first time window, in which the client device 102 must evaluate the one or more conditions to determine whether the one or more conditions are satisfied—evaluate the one or more conditions to determine whether the one or more conditions are satisfied.

At block 306, the client device 102 may, in response to determining that the one or more conditions are satisfied, notify the server device 104 regarding the one or more values detected by the client device 102. In some embodiments, to notify the server device 104 regarding the one or more values detected by the client device 102 at block 306, the client device 102 may send the one or more values detected by the client device 102 to the server device 104, for example, by performing a Notify operation as defined in Lightweight Machine to Machine Technical Specification, approved version 1.0.1, Open Mobile Alliance, Jul. 4, 2017.

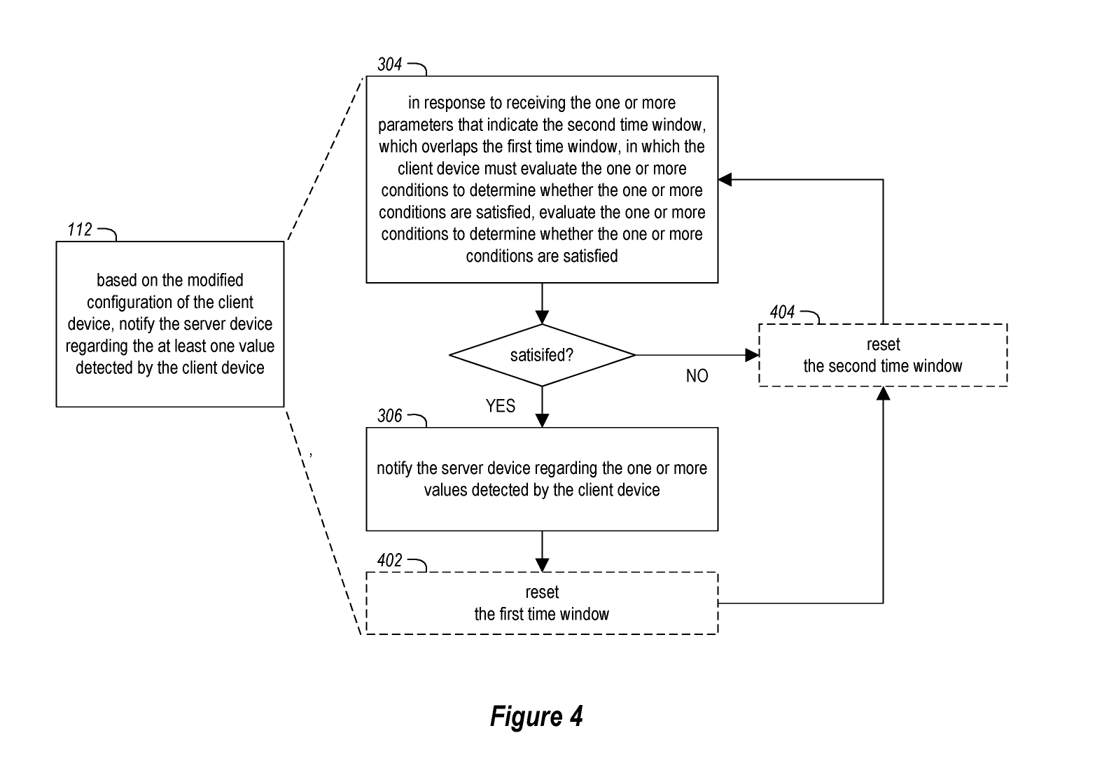

As shown in FIG. 4, in some embodiments, block 112 (FIG. 1) may include one or more blocks, such as, blocks 304 and 306 (FIG. 3), block 402, and block 404, which may be performed by one or more processors of one or more computing devices—such as one or more processors 802 (FIG. 8) that may be configured with notification logic 810 which performs blocks 304, 306, 402, and 404, performs other functionality (including other functionality described herein), or performs any combination thereof.

As shown in FIG. 4, at block 304, the client device 102 may—in response to receiving the one or more parameters that indicate the second time window, which overlaps the first time window, in which the client device 102 must evaluate the one or more conditions to determine whether the one or more conditions are satisfied—evaluate the one or more conditions to determine whether the one or more conditions are satisfied. In response to determining that the one or more conditions are satisfied, the client device 102 may, at block 306, notify the server device 104 regarding the one or more values detected by the client device 102, may reset the first time window at block 402, and may reset the second time window at block 404. In response to evaluating the one or more conditions to determine whether the one or more conditions are satisfied and determining that the one or more conditions are not satisfied, the client device 102 may reset the second time window at block 404.

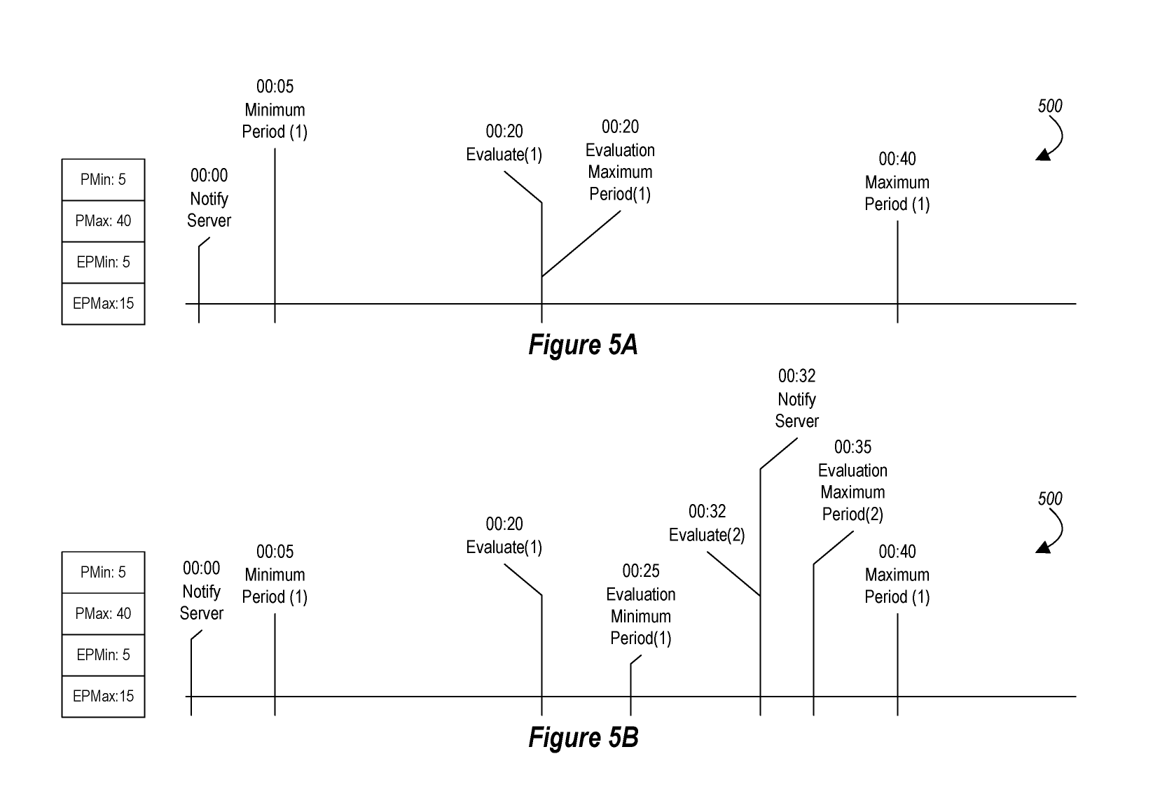

FIGS. 5A and 5B are diagrams illustrating an embodiment timeline 500 for providing notifications in which the parameter 202, labeled as “PMin”, may indicate a minimum time the client device 102 must wait between two adjacent notifications to the server device 104 (for example, five minutes); the parameter 204, labeled as “PMax”, may indicate a maximum time the client device 102 may wait between two adjacent notifications to the server device 104 (for example, forty minutes); the parameter 212, labeled as “EPMin”, may indicate a minimum time the client device 102 must wait between two adjacent evaluations of the one or more conditions made in the first time window (for example, five minutes); and the parameter 214, labeled as “EPMax”, may indicate both (1) a maximum time the client device may wait between two adjacent evaluations of the one or more conditions made in the first time window and (2) a maximum time from the start of the first time window the client device may wait to evaluate the one or more conditions (for example, fifteen minutes).

As shown in FIG. 5A at time 00:00 (i.e., 0 hours:0 minutes), the client device 102 may notify the server device 104 (such as, at block 112 and/or at block 306 as discussed above). With this notification at time 00:00, the first time window in which the client device 102 must notify the server device 104 regarding one or more values detected by the client device 102 starts at time 00:05 (i.e., five minutes from the notification, where PMin indicates five minutes) and ends at time 00:40 (i.e., forty minutes from the notification, where PMax indicates forty minutes). With the first time window starting at time 00:05, the second time window in which the client device 102 must evaluate the one or more conditions to determine whether the one or more conditions are satisfied starts at time 00:05 (i.e., aligned with the start of the first time window) and ends at time 00:20 (i.e., fifteen minutes from the start of the first time window, where EPMax indicates fifteen minutes).

As shown in FIG. 5A, the client device 102 may wait until time 00:20 to evaluate the one or more conditions to determine whether the one or more conditions are satisfied (such as, at block 304 as discussed above). Thus, in embodiments in which the client device 102 is configured to go into and out of a low power state (such as, LTE Power Saving Mode), the client device 102 may notify the server device 104 and go into the lower power state at time 00:00 and may go out of the lower power state and evaluate the one or more conditions to determine whether the one or more conditions are satisfied at time 00:20.

As shown in FIG. 5B, in response to evaluating (at time 00:20) the one or more conditions to determine whether the one or more conditions are satisfied and determining that the one or more conditions are not satisfied, the client device 102 may reset the second time window (such as, at block 404 as discussed above). In particular, with the evaluation at time 00:20, the client device 102 may reset the second time window to start at time 00:25 (i.e., five minutes from the evaluation, where EPMin indicates five minutes) and end at time 00:35 (i.e., fifteen minutes from the evaluation, where EPMax indicates fifteen minutes).

As shown in FIG. 5B at any time in the second time window (e.g., at time 00:32), the client device 102 may evaluate the one or more conditions to determine whether the one or more conditions are satisfied (such as, at block 304 as discussed above), and in response to determining that the one or more conditions are satisfied, the client device 102 may notify the server device 104 (such as, at block 112 and/or at block 306 as discussed above). Thus, in embodiments in which the client device 102 is configured to go into and out of a low power state (such as, LTE Power Saving Mode), the client device 102 may evaluate the one or more conditions to determine whether the one or more conditions are satisfied and go into the lower power state at time 00:20 and may go out of the lower power state and evaluate the one or more conditions to determine whether the one or more conditions are satisfied at time 00:32.

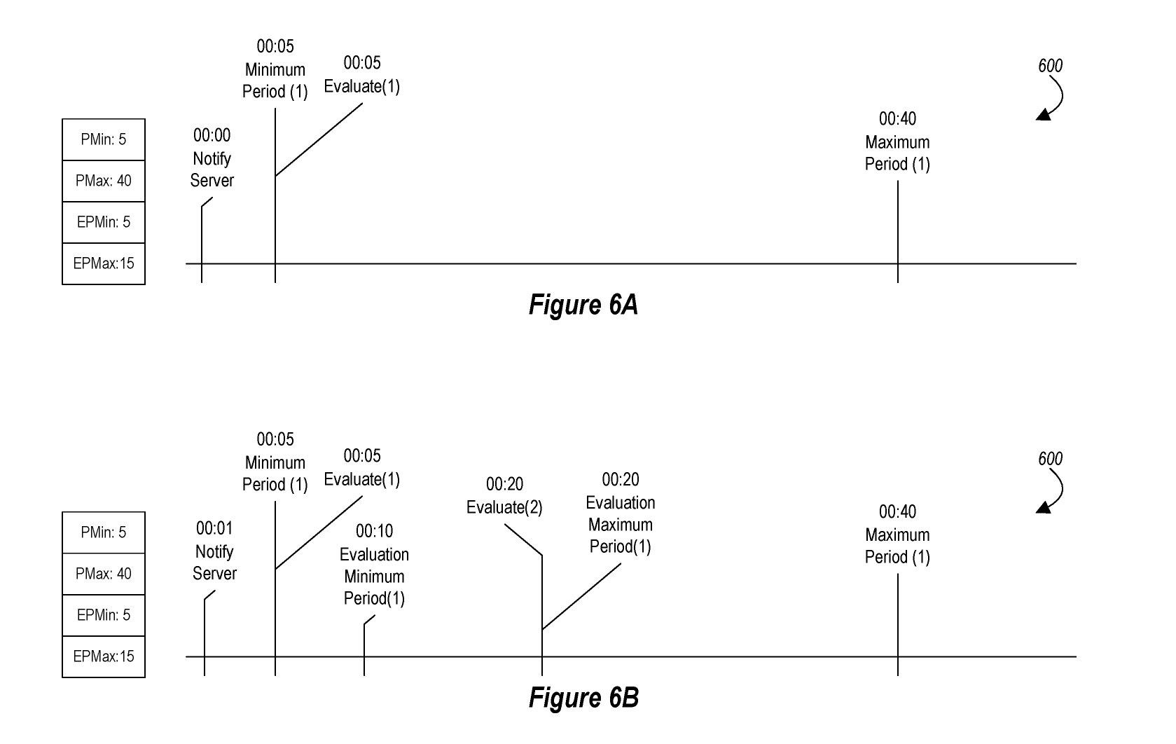

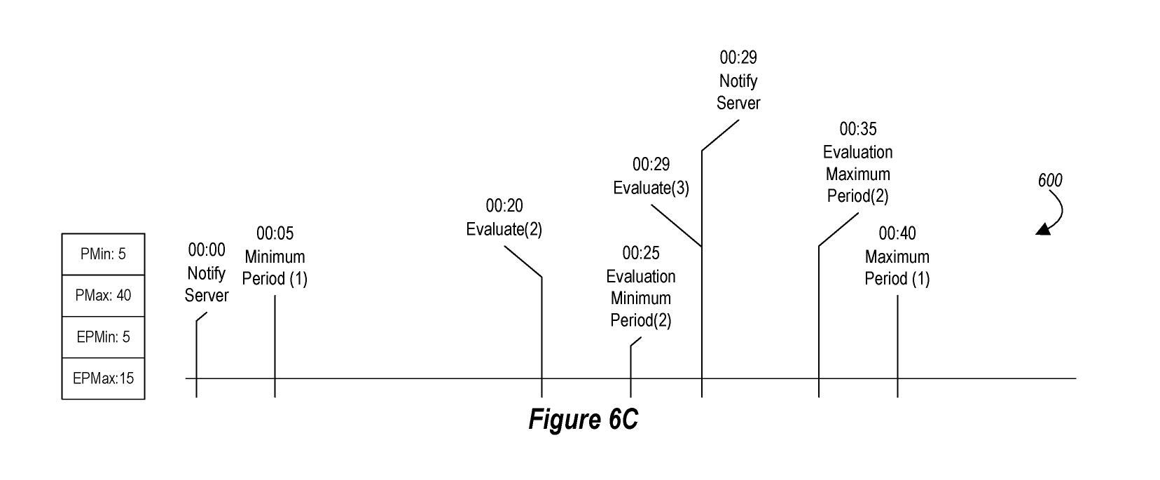

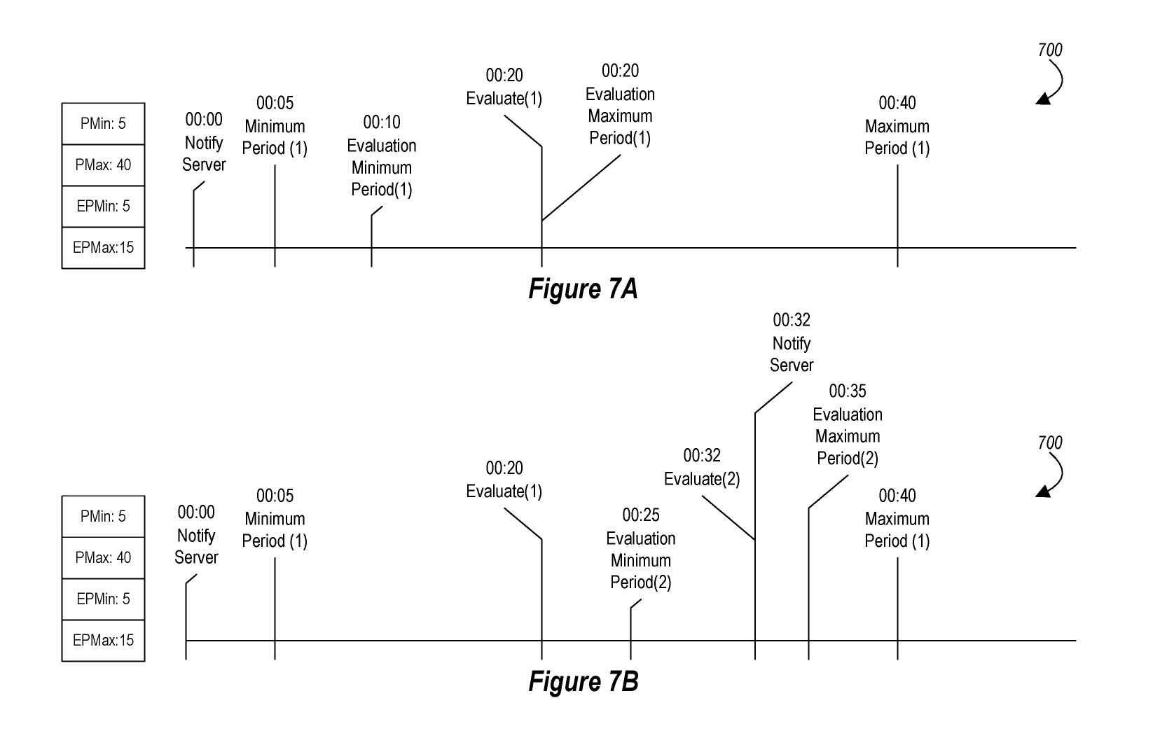

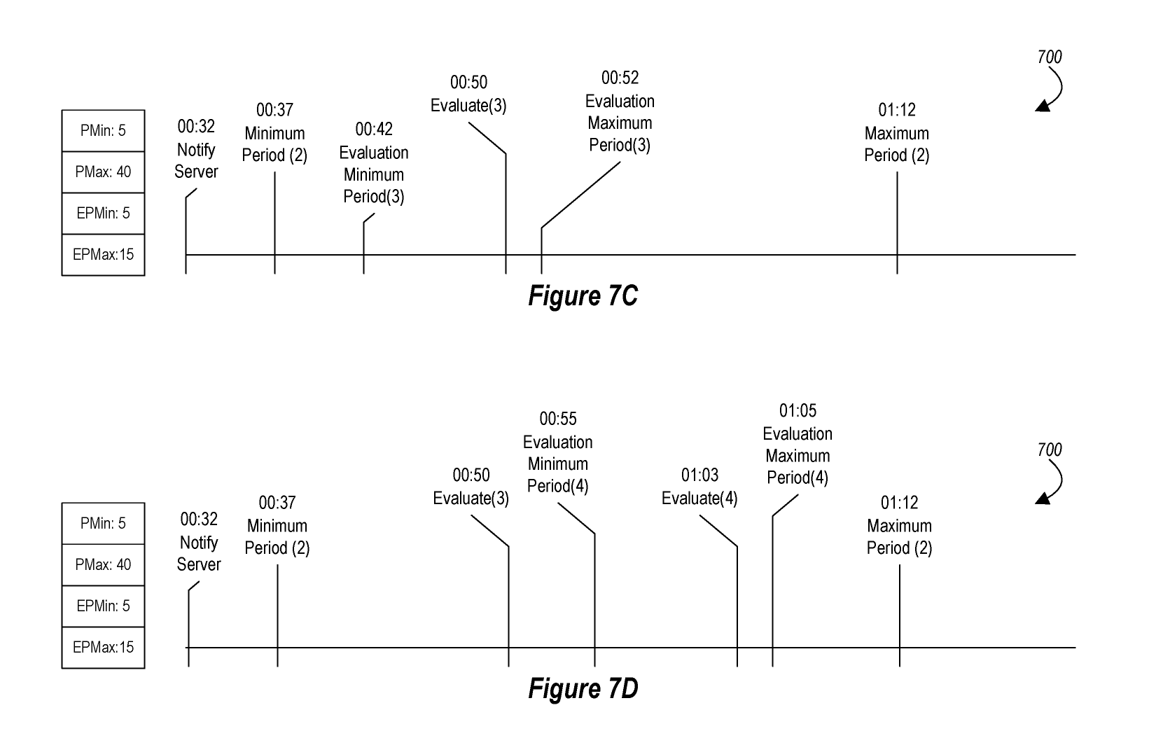

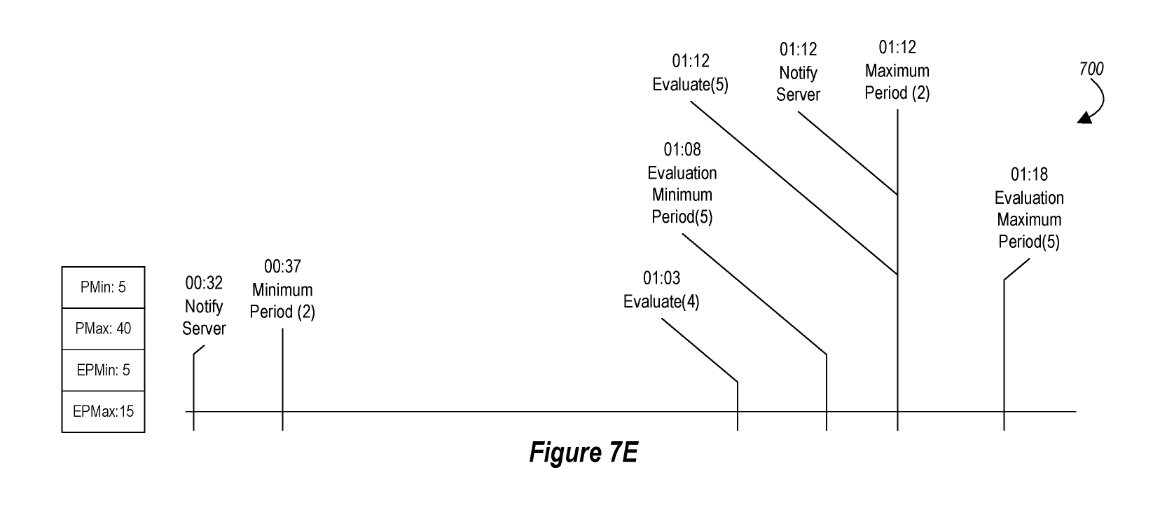

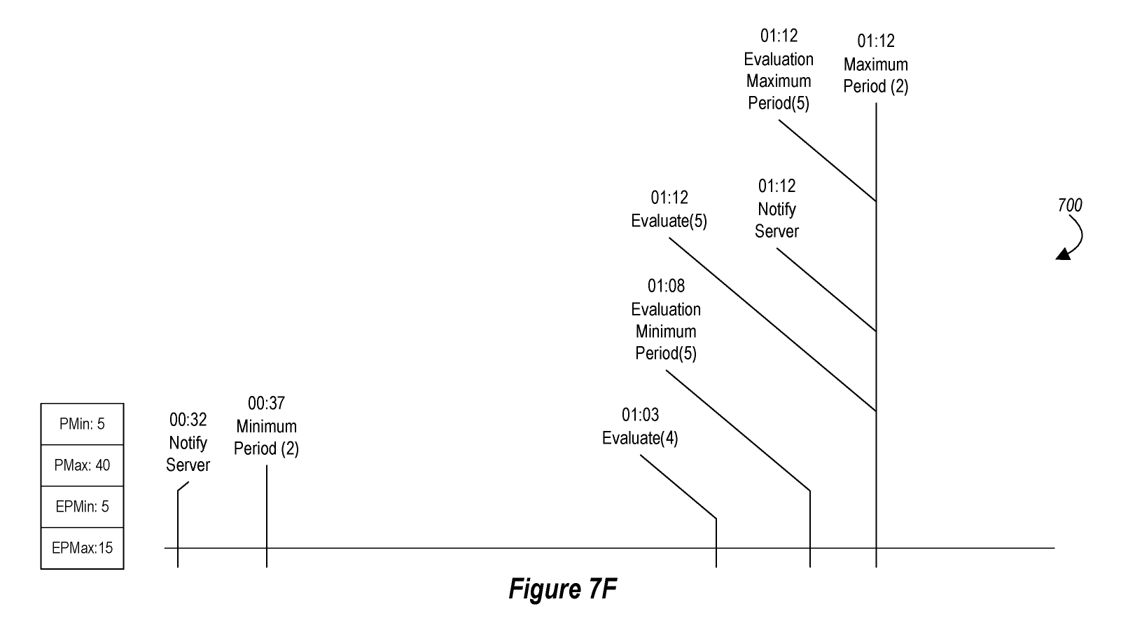

Thus, as shown in FIGS. 5A and 5B (and will be apparent from FIGS. 6A to 6C and 7A to 7F), in embodiments in which the client device 102 is configured to go into and out of a low power state, the client device 102 may optionally be in the lower power state (1) between a notification of the server device 104 and subsequent, adjacent evaluation of the one or more conditions and/or (2) between adjacent evaluations of the one or more conditions. Applicants have observed that this may be advantageous when, for instance, the client device 102 has a limited power supply and/or is intended to operate for months or years without completely depleting the limited power supply, for example, because this may prolong the life of the limited power supply of the client device 102. Applicants have observed that this may also be advantageous when, for instance, the power that the client device 102 consumes is expensive and/or in other situations, for example, because this may reduce the cost of using the client device 102.

Moreover, as shown in FIGS. 5A and 5B (and will be apparent from FIGS. 6A to 6C and 7A to 7F), the client device 102—in response to receiving the one or more parameters that indicate the second time window, which overlaps the first time window, in which the client device 102 must evaluate the one or more conditions to determine whether the one or more conditions are satisfied—may evaluate the one or more conditions more often, rather than merely waiting until the end of the first time window to evaluate the one or more conditions. For example, as shown in FIGS. 5A and 5B (and will be apparent from FIGS. 6A to 6C and 7A to 7E), the client device 102 may evaluate the one or more conditions more often in embodiments in which the second time window has a shorter duration than the first time window. Applicants have observed that, by evaluating the one or more conditions more often rather than merely waiting until the end of the first time window to evaluate the one or more conditions, the client device 102 may advantageously notify the server device 104 in situations when the one or more conditions are temporarily satisfied prior to the end of the first time window, but the one or more conditions are no longer satisfied by the end of the first time window. Applicants have thus observed that this may help provide more accurate notification of the server device 104.

In addition, as shown in FIGS. 5A and 5B (and will be apparent from FIGS. 6A to 6C and 7A to 7F), the client device 102—in response to receiving the one or more parameters that indicate the second time window, which overlaps the first time window, in which the client device 102 must evaluate the one or more conditions to determine whether the one or more conditions are satisfied—may evaluate the one or more conditions more often (which may help provide more accurate notification of the server device 104), rather than merely waiting until the end of the first time window to evaluate the one or more conditions, but also may refrain from notifying the server device 104 when the conditions are not satisfied (which may help prolong the life of a limited power supply of the client device 102). In particular, Applicants have observed that, by refraining from notifying the server device 104 when the conditions are not satisfied (i.e., using a “conditional” notification solution), the client device 102 may advantageously avoid the additional power consumption required to notify the server device 104—which may prolong the life of a limited power supply of the client device 102 relative to an alternative, “unconditional”-only notification solution.

Thus, as shown in FIGS. 5A and 5B (and will be apparent from FIGS. 6A to 6C and 7A to 7F), features related to a first time window in which the client device must notify a server device regarding one or more values detected by the client device and features related to a second time window, which overlaps the first time window, in which the client device must evaluate the one or more conditions to determine whether the one or more conditions are satisfied may collectively help provide notify the server device 104 with reduced power consumption and increased accuracy.

FIGS. 6A, 6B and 6C are diagrams illustrating an embodiment timeline 600 for providing notifications in which the parameter 202, labeled as “PMin”, may indicate a minimum time the client device 102 must wait between two adjacent notifications to the server device 104 (for example, five minutes); the parameter 204, labeled as “PMax”, may indicate a maximum time the client device 102 may wait between two adjacent notifications to the server device 104 (for example, forty minutes); the parameter 212, labeled as “EPMin”, may indicate a minimum time the client device must wait between two adjacent evaluations of the one or more conditions made in the first time window (for example, five minutes); and the parameter 214, labeled as “EPMax”, may indicate a maximum time the client device may wait between two adjacent evaluations of the one or more conditions made in the first time window (for example, fifteen minutes).

In addition, in the timeline 600, the client device 102 may be configured to perform a mandatory evaluation of the one or more conditions, for example, an evaluation of the one or more conditions at the start of the first time window. For example, in some embodiments, at block 108 and/or at block 302, the client device 102 may receive one or more parameters that indicate the client device 102 must evaluate, at a defined time (e.g., the start of the first time window), the one or more conditions to determine whether the one or more conditions are satisfied. These one or more parameters may comprise the parameter 212, the parameter 214, one or more other parameters, or any combination thereof.

As shown in FIG. 6A at time 00:00 (i.e., 0 hours: 0 minutes), the client device 102 may notify the server device 104 (such as, at block 112 and/or at block 306 as discussed above). With this notification at time 00:00, the first time window in which the client device 102 must notify the server device 104 regarding one or more values detected by the client device 102 starts at time 00:05 (i.e., five minutes from the notification, where PMin indicates five minutes) and ends at time 00:40 (i.e., forty minutes from the notification, where PMax indicates forty minutes).

As shown in FIG. 6A at the start of the first time window (i.e., at time 00:05), the client device 102 may perform a mandatory evaluation of the one or more conditions to determine whether the one or more conditions are satisfied (such as, at block 304 as discussed above), but may determine that the one or more conditions are not satisfied.

As shown in FIG. 6B, with the evaluation at time 00:05 and the client device 102 determining that the one or more conditions are not satisfied, the second time window in which the client device 102 must evaluate the one or more conditions to determine whether the one or more conditions are satisfied starts at time 00:10 (i.e., five minutes from the evaluation, where EPMin indicates five minutes) and ends at time 00:20 (i.e., fifteen minutes from the evaluation, where EPMax indicates fifteen minutes).

As shown in FIG. 6B, the client device 102 may wait until time 00:20 to evaluate the one or more conditions to determine whether the one or more conditions are satisfied (such as, at block 304 as discussed above).

As shown in FIG. 6C, in response to evaluating (at time 00:20) the one or more conditions to determine whether the one or more conditions are satisfied and determining that the one or more conditions are not satisfied, the client device 102 may reset the second time window (such as, at block 404 as discussed above). In particular, with the evaluation at time 00:20, the client device 102 may reset the second time window to start at time 00:25 (i.e., five minutes from the evaluation, where EPMin indicates five minutes) and end at time 00:35 (i.e., fifteen minutes from the evaluation, where EPMax indicates fifteen minutes).

As shown in FIG. 6C at any time in the second time window (e.g., at time 00:29), the client device 102 may evaluate the one or more conditions to determine whether the one or more conditions are satisfied (such as, at block 304 as discussed above), and in response to determining that the one or more conditions are satisfied, the client device 102 may notify the server device 104 (such as, at block 112 and/or at block 306 as discussed above).

FIGS. 7A, 7B, 7C, 7D and 7E are diagrams illustrating an embodiment timeline 700 for providing notifications in which the parameter 202, labeled as “PMin”, may indicate a minimum time the client device 102 must wait between two adjacent notifications to the server device 104 (for example, five minutes); the parameter 204, labeled as “PMax”, may indicate a maximum time the client device 102 may wait between two adjacent notifications to the server device 104 (for example, forty minutes); the parameter 212, labeled as “EPMin”, may indicate both (1) a minimum time the client device must wait between two adjacent evaluations of the one or more conditions made in the first time window and (2) a minimum time from the start of the first time window the client device must wait to evaluate the one or more conditions (for example, five minutes); and the parameter 214, labeled as “EPMax”, may indicate both (1) a maximum time the client device may wait between two adjacent evaluations of the one or more conditions made in the first time window and (2) a maximum time from the start of the first time window the client device may wait to evaluate the one or more conditions (for example, fifteen minutes).

As shown in FIG. 7A at time 00:00 (i.e., 0 hours:0 minutes), the client device 102 may notify the server device 104 (such as, at block 112 and/or at block 306 as discussed above). With this notification at time 00:00, the first time window in which the client device 102 must notify the server device 104 regarding one or more values detected by the client device 102 starts at time 00:05 (i.e., five minutes from the notification, where PMin indicates five minutes) and ends at time 00:40 (i.e., forty minutes from the notification, where PMax indicates forty minutes). With the first time window starting at time 00:05, the second time window in which the client device 102 must evaluate the one or more conditions to determine whether the one or more conditions are satisfied starts at time 00:10 (i.e., five minutes the start of the first time window, where EPMin indicates five minutes) and ends at time 00:20 (i.e., fifteen minutes from the start of the first time window, where EPMax indicates fifteen minutes).

As shown in FIG. 7A, the client device 102 may wait until time 00:20 to evaluate the one or more conditions to determine whether the one or more conditions are satisfied (such as, at block 304 as discussed above).

As shown in FIG. 7B, in response to evaluating (at time 00:20) the one or more conditions to determine whether the one or more conditions are satisfied and determining that the one or more conditions are not satisfied, the client device 102 may reset the second time window (such as, at block 404 as discussed above). In particular, with the evaluation at time 00:20, the client device 102 may reset the second time window to start at time 00:25 (i.e., five minutes from the evaluation, where EPMin indicates five minutes) and end at time 00:35 (i.e., fifteen minutes from the evaluation, where EPMax indicates fifteen minutes).

As shown in FIG. 7B at any time in the second time window (e.g., at time 00:32), the client device 102 may evaluate the one or more conditions to determine whether the one or more conditions are satisfied (such as, at block 304 as discussed above), and in response to determining that the one or more conditions are satisfied, the client device 102 may notify the server device 104 (such as, at block 112 and/or at block 306 as discussed above).

As shown in FIG. 7C, in response to notifying the server device 104 (at time 00:32), the client device 102 may reset the first time window (such as, at block 402 as discussed above) and reset the second time window (such as, at block 404 as discussed above). In particular, with the notification at time 00:32, the client device 102 may reset the first time window to start at time 00:37 (i.e., five minutes from the notification, where PMin indicates five minutes) and end at time 01:12 (i.e., forty minutes from the notification, where PMax indicates forty minutes). In addition, with the first time window starting at time 00:37, the client device 102 may reset the second time window to start at time 00:42 (i.e., five minutes the start of the first time window, where EPMin indicates five minutes) and end at time 00:52 (i.e., fifteen minutes from the start of the first time window, where EPMax indicates fifteen minutes).

As shown in FIG. 7C at any time in the second time window (e.g., at time 00:50), the client device 102 may evaluate the one or more conditions to determine whether the one or more conditions are satisfied (such as, at block 304 as discussed above).

As shown in FIG. 7D, in response to evaluating (at time 00:50) the one or more conditions to determine whether the one or more conditions are satisfied and determining that the one or more conditions are not satisfied, the client device 102 may reset the second time window (such as, at block 404 as discussed above). In particular, with the evaluation at time 00:50, the client device 102 may reset the second time window to start at time 00:55 (i.e., five minutes from the evaluation, where EPMin indicates five minutes) and end at time 01:05 (i.e., fifteen minutes from the evaluation, where EPMax indicates fifteen minutes).

As shown in FIG. 7D at any time in the second time window (e.g., at time 01:03), the client device 102 may evaluate the one or more conditions to determine whether the one or more conditions are satisfied (such as, at block 304 as discussed above).

In some embodiments, as shown in FIG. 7E, in response to evaluating (at time 01:03) the one or more conditions to determine whether the one or more conditions are satisfied and determining that the one or more conditions are not satisfied, the client device 102 may reset the second time window (such as, at block 404 as discussed above). In particular, with the evaluation at time 01:03, the client device 102 may reset the second time window to start at time 01:08 (i.e., five minutes from the evaluation, where EPMin indicates five minutes) and end at time 01:18 (i.e., fifteen minutes from the evaluation, where EPMax indicates fifteen minutes).

As shown in FIG. 7E, the second time window is partially within the first time window, e.g., the second time window starts at time 01:08, which is before the end of the first time window at time 01:12, and ends at time 01:18, which is after the end of the first time window. In some embodiments in which the second time window ends after the first time window as shown in FIG. 7E, the client device 102 may wait until the end of the first time window and may then notify the server device 104 (such as, at block 112 and/or at block 306 as discussed above) because the end of the first time window has arrived and no other notifications have occurred in the first time window. In some embodiments in which the second time window ends after the first time window as shown in FIG. 7E, the client device 102 may at any time in the remainder of the first time window evaluate the one or more conditions to determine whether the one or more conditions are satisfied (such as, at block 304 as discussed above), and in response to determining that the one or more conditions are satisfied, the client device 102 may notify the server device 104 (such as, at block 112 and/or at block 306 as discussed above).

As an alternative to FIG. 7E, in some embodiments, as shown in FIG. 7F, in response to evaluating (at time 01:03) the one or more conditions to determine whether the one or more conditions are satisfied and determining that the one or more conditions are not satisfied, the client device 102 may reset the second time window (such as, at block 404 as discussed above). In particular, with the evaluation at time 01:03, the client device 102 may reset the second time window to start at time 01:08 (i.e., five minutes from the evaluation, where EPMin indicates five minutes) and end at time 1:12, i.e., aligned with the end of the first time window, where EPMax indicates fifteen minutes and fifteen minutes from the evaluation (i.e., time 01:18) is after the end of the first time window. Thus, in some embodiments, when the client device 102 resets the second time window, the client device 102 may align the end of the second time window with the end of the first time window in situations where EPMax indicates a duration that would extend past the end of the first time window.

As shown in FIG. 7F, the second time window is completely within the first time window, e.g., the second time window starts at time 01:08, which is before the end of the first time window at time 01:12, and ends at time 01:12, which is aligned with the end of the first time window. Thus, the client device 102 may at any time in the remainder of the first time window evaluate the one or more conditions to determine whether the one or more conditions are satisfied (such as, at block 304 as discussed above), and in response to determining that the one or more conditions are satisfied, the client device 102 may notify the server device 104 (such as, at block 112 and/or at block 306 as discussed above). But even if the client device 102 determines that the one or more conditions are not satisfied, the client device 102 may notify the server device 104 (such as, at block 112 and/or at block 306 as discussed above) when the end of the first time window arrives and no other notifications have occurred in the first time window.

Various embodiments (including, but not limited to, embodiments discussed above with reference to FIGS. 1 to 7F) may be implemented in any computing device, one example of which is illustrated in FIG. 8. For example, the computing device 800 may include one or more processors 802 coupled to a touch screen controller and one or more internal memory 804. The processor 802 may be one or more multicore integrated circuits designated for general or specific processing tasks. The internal memory 804 may be volatile or non-volatile memory, and may also be secure and/or encrypted memory, or unsecure and/or unencrypted memory, or any combination thereof. The touch screen controller and the processor 802 may also be coupled to a touch screen panel, such as a resistive-sensing touch screen, capacitive-sensing touch screen, infrared sensing touch screen, etc. The computing device 800 may have one or more radio signal transceivers 806 (e.g., Peanut®, Bluetooth®, Zigbee®, Wi-Fi, RF, cellular, etc.) and antennae, for sending and receiving, coupled to each other and/or to the processor 802. The transceiver 806 and antennae may be used with the above-mentioned circuitry to implement the various wireless transmission protocol stacks and interfaces. The computing device 800 may include one or more cellular network wireless modems 808 that enable communication via one or more cellular networks and that are coupled to the processor.

The computing device 800 may include a peripheral device connection interface coupled to the processor 802. The peripheral device connection interface may be singularly configured to accept one type of connection, or multiply configured to accept various types of physical and communication connections, common or proprietary, such as USB, FireWire, Thunderbolt, Ethernet, or PCIe. The peripheral device connection interface may also be coupled to a similarly configured peripheral device connection port. The computing device 800 may also include speakers for providing audio outputs.

The computing device 800 may also include a housing—which may be constructed of plastic, metal, one or more other materials, or a combination of thereof—for containing all or some of the components discussed herein. The computing device 800 may include a power source coupled to the processor 802, such as a disposable or rechargeable battery. The rechargeable battery may also be coupled to the peripheral device connection port to receive a charging current from a source external to the computing device 800.

The processor 802 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processor 802. The processor 802 and may include internal memory sufficient to store the application software instructions. In many devices, the internal memory may be a volatile or nonvolatile memory, such as flash memory, or a mixture of both. For the purposes of this description, a general reference to memory refers to memory accessible by the processor 802 including internal memory or removable memory plugged into the device and memory within the processor 802 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The methods and systems described above require no particular component or function. Thus, any described component or function—despite its advantages—is optional. Also, some or all of the described components and functions described above may be used in connection with any number of other suitable components and functions.

Any person skilled in the art will also appreciate that although the exemplary embodiments discussed above have been described with respect to M2M server devices and/or M2M client devices, these aspects and features may also be used in connection with other types of computing devices.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

Moreover, although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method for providing notifications, the method comprising:
by a client device:
receiving one or more defined parameters comprising:
one or more parameters that indicate a first time window in which the client device must notify a server device regarding one or more values detected by the client device;
one or more parameters that indicate one or more conditions that, if satisfied, the client device must notify the server device regarding the one or more values detected by the client device; and
one or more parameters that indicate a second time window, which overlaps the first time window, in which the client device must evaluate the one or more conditions to determine whether the one or more conditions are satisfied;
modifying a configuration of the client device to, based on the received one or more defined parameters, notify the server device regarding at least one value detected by the client device; and
based on the modified configuration of the client device, notifying the server device regarding the at least one value detected by the client device.

2. The method of claim 1, wherein the one or more parameters that indicate a second time window, which overlaps the first time window, in which the client device must evaluate the one or more conditions to determine whether the one or more conditions are satisfied comprise at least one of:
a parameter that indicates a maximum time the client device may wait between two adjacent evaluations of the one or more conditions made in the first time window;
a parameter that indicates a maximum time the client device may wait between two adjacent evaluations of the one or more conditions;
a parameter that indicates a minimum time the client device must wait between two adjacent evaluations of the one or more conditions made in the first time window;
a parameter that indicates a minimum time the client device must wait between two adjacent evaluations of the one or more conditions;
a parameter that indicates a maximum time from the start of the first time window the client device may wait to evaluate the one or more conditions; or
a parameter that indicates a minimum time from the start of the first time window the client device must wait to evaluate the one or more conditions.

3. The method of claim 2, wherein the one or more parameters that indicate a first time window in which the client device must notify the server device regarding one or more values detected by the client device comprise at least one of:
a parameter that indicates a maximum time the client device may wait between two adjacent notifications to the server device; or
a parameter that indicates a minimum time the client device must wait between two adjacent notifications to the server device.

4. The method of claim 3, wherein the one or more parameters that indicate one or more conditions that, if satisfied, the client device must notify the server device regarding the one or more values detected by the client device comprise at least one of:
one or more parameters that indicate that the client device must notify the server device if a value detected by the client device satisfies a threshold;
a parameter that indicates that the client device must notify the server device if a value detected by the client device is greater than a threshold value;
a parameter that indicates that the client device must notify the server device if a value detected by the client device is less than a threshold value; or
a parameter that indicates that the client device must notify the server device if a value detected by the client device varies a threshold amount relative to a previous value of which the client device last notified the server device.

5. The method of claim 1, wherein notifying the server device regarding the at least one value detected by the client device based on the modified configuration of the client device, comprises:
in response to receiving the one or more parameters that indicate the second time window, which overlaps the first time window, in which the client device must evaluate the one or more conditions to determine whether the one or more conditions are satisfied, evaluating the one or more conditions to determine whether the one or more conditions are satisfied; and
in response to determining that the one or more conditions are satisfied, notifying the server device regarding the one or more values detected by the client device.

6. The method of claim 1, wherein notifying the server device regarding the at least one value detected by the client device based on the modified configuration of the client device, comprises:
in response to receiving the one or more parameters that indicate the second time window, which overlaps the first time window, in which the client device must evaluate the one or more conditions to determine whether the one or more conditions are satisfied, evaluating the one or more conditions to determine whether the one or more conditions are satisfied; and
in response to determining that the one or more conditions are satisfied:
notifying the server device regarding the one or more values detected by the client device;
resetting the first time window; and
resetting the second time window.

7. The method of claim 1, wherein notifying the server device regarding the at least one value detected by the client device based on the modified configuration of the client device, comprises:
in response to receiving the one or more parameters that indicate the second time window, which overlaps the first time window, in which the client device must evaluate the one or more conditions to determine whether the one or more conditions are satisfied, evaluating the one or more conditions to determine whether the one or more conditions are satisfied; and
in response to evaluating the one or more conditions to determine whether the one or more conditions are satisfied and determining that the one or more conditions are not satisfied, resetting the second time window.

8. The method of claim 1, wherein receiving one or more defined parameters comprises receiving the one or more defined parameters from the server device.

9. A method for obtaining notifications, the method comprising:
by a server device:
sending, to a client device, one or more defined parameters comprising:
one or more parameters that indicate a first time window in which the client device must notify the server device regarding one or more values detected by the client device;
one or more parameters that indicate one or more conditions that, if satisfied, the client device must notify the server device regarding the one or more values detected by the client device; and
one or more parameters that indicate a second time window, which overlaps the first time window, in which the client device must evaluate the one or more conditions to determine whether the one or more conditions are satisfied;
the client device configured to (1) receive the one or more defined parameters sent by the server device, (2) modify a configuration of the client device to, based on the received one or more defined parameters, notify the server device regarding at least one value detected by the client device and (3) based on the modified configuration of the client device, notify the server device regarding the at least one value detected by the client device; and
receiving, from the client device, the notification regarding the at least one value detected by the client device.

10. The method of claim 9, wherein the one or more parameters that indicate a second time window, which overlaps the first time window, in which the client device must evaluate the one or more conditions to determine whether the one or more conditions are satisfied comprise at least one of:
a parameter that indicates a maximum time the client device may wait between two adjacent evaluations of the one or more conditions made in the first time window;
a parameter that indicates a maximum time the client device may wait between two adjacent evaluations of the one or more conditions;
a parameter that indicates a minimum time the client device must wait between two adjacent evaluations of the one or more conditions made in the first time window;
a parameter that indicates a minimum time the client device must wait between two adjacent evaluations of the one or more conditions;
a parameter that indicates a maximum time from the start of the first time window the client device may wait to evaluate the one or more conditions; or
a parameter that indicates a minimum time from the start of the first time window the client device must wait to evaluate the one or more conditions.

11. The method of claim 10, wherein the one or more parameters that indicate a first time window in which the client device must notify the server device regarding one or more values detected by the client device comprise at least one of:
a parameter that indicates a maximum time the client device may wait between two adjacent notifications to the server device; or
a parameter that indicates a minimum time the client device must wait between two adjacent notifications to the server device.

12. The method of claim 11, wherein the one or more parameters that indicate one or more conditions that, if satisfied, the client device must notify the server device regarding the one or more values detected by the client device comprise at least one of:
one or more parameters that indicate that the client device must notify the server device if a value detected by the client device satisfies a threshold;
a parameter that indicates that the client device must notify the server device if a value detected by the client device is greater than a threshold value;
a parameter that indicates that the client device must notify the server device if a value detected by the client device is less than a threshold value; or
a parameter that indicates that the client device must notify the server device if a value detected by the client device varies a threshold amount relative to a previous value of which the client device last notified the server device.

13. An apparatus for providing notifications, the apparatus comprising:
one or more processors configured with processor-executable instructions to perform operations comprising:
by a client device:
receiving one or more defined parameters comprising:
one or more parameters that indicate a first time window in which the client device must notify a server device regarding one or more values detected by the client device;
one or more parameters that indicate one or more conditions that, if satisfied, the client device must notify the server device regarding the one or more values detected by the client device; and
one or more parameters that indicate a second time window, which overlaps the first time window, in which the client device must evaluate the one or more conditions to determine whether the one or more conditions are satisfied;
modifying a configuration of the client device to, based on the received one or more defined parameters, notify the server device regarding at least one value detected by the client device; and
based on the modified configuration of the client device, notifying the server device regarding the at least one value detected by the client device.

14. The apparatus of claim 13, wherein the one or more parameters that indicate a second time window, which overlaps the first time window, in which the client device must evaluate the one or more conditions to determine whether the one or more conditions are satisfied comprise at least one of:
a parameter that indicates a maximum time the client device may wait between two adjacent evaluations of the one or more conditions made in the first time window;
a parameter that indicates a maximum time the client device may wait between two adjacent evaluations of the one or more conditions;
a parameter that indicates a minimum time the client device must wait between two adjacent evaluations of the one or more conditions made in the first time window;
a parameter that indicates a minimum time the client device must wait between two adjacent evaluations of the one or more conditions;
a parameter that indicates a maximum time from the start of the first time window the client device may wait to evaluate the one or more conditions; or
a parameter that indicates a minimum time from the start of the first time window the client device must wait to evaluate the one or more conditions.

15. The apparatus of claim 14, wherein the one or more parameters that indicate a first time window in which the client device must notify the server device regarding one or more values detected by the client device comprise at least one of:
a parameter that indicates a maximum time the client device may wait between two adjacent notifications to the server device; or
a parameter that indicates a minimum time the client device must wait between two adjacent notifications to the server device.

16. The apparatus of claim 15, wherein the one or more parameters that indicate one or more conditions that, if satisfied, the client device must notify the server device regarding the one or more values detected by the client device comprise at least one of:
one or more parameters that indicate that the client device must notify the server device if a value detected by the client device satisfies a threshold;
a parameter that indicates that the client device must notify the server device if a value detected by the client device is greater than a threshold value;
a parameter that indicates that the client device must notify the server device if a value detected by the client device is less than a threshold value; or
a parameter that indicates that the client device must notify the server device if a value detected by the client device varies a threshold amount relative to a previous value of which the client device last notified the server device.

17. The apparatus of claim 13, wherein notifying the server device regarding the at least one value detected by the client device based on the modified configuration of the client device, comprises:
in response to receiving the one or more parameters that indicate the second time window, which overlaps the first time window, in which the client device must evaluate the one or more conditions to determine whether the one or more conditions are satisfied, evaluating the one or more conditions to determine whether the one or more conditions are satisfied; and
in response to determining that the one or more conditions are satisfied, notifying the server device regarding the one or more values detected by the client device.

18. The apparatus of claim 13, wherein notifying the server device regarding the at least one value detected by the client device based on the modified configuration of the client device, comprises:
in response to receiving the one or more parameters that indicate the second time window, which overlaps the first time window, in which the client device must evaluate the one or more conditions to determine whether the one or more conditions are satisfied, evaluating the one or more conditions to determine whether the one or more conditions are satisfied; and
in response to determining that the one or more conditions are satisfied:
notifying the server device regarding the one or more values detected by the client device;
resetting the first time window; and
resetting the second time window.

19. The apparatus of claim 13, wherein notifying the server device regarding the at least one value detected by the client device based on the modified configuration of the client device, comprises:
in response to receiving the one or more parameters that indicate the second time window, which overlaps the first time window, in which the client device must evaluate the one or more conditions to determine whether the one or more conditions are satisfied, evaluating the one or more conditions to determine whether the one or more conditions are satisfied; and
in response to evaluating the one or more conditions to determine whether the one or more conditions are satisfied and determining that the one or more conditions are not satisfied, resetting the second time window.

20. The apparatus of claim 13, wherein receiving one or more defined parameters comprises receiving the one or more defined parameters from the server device.

21. An apparatus for obtaining notifications, the apparatus comprising:
one or more processors configured with processor-executable instructions to perform operations comprising:
by a server device:
sending, to a client device, one or more defined parameters comprising:
one or more parameters that indicate a first time window in which the client device must notify the server device regarding one or more values detected by the client device;
one or more parameters that indicate one or more conditions that, if satisfied, the client device must notify the server device regarding the one or more values detected by the client device; and
one or more parameters that indicate a second time window, which overlaps the first time window, in which the client device must evaluate the one or more conditions to determine whether the one or more conditions are satisfied;
the client device configured to (1) receive the one or more defined parameters sent by the server device, (2) modify a configuration of the client device to, based on the received one or more defined parameters, notify the server device regarding at least one value detected by the client device and (3) based on the modified configuration of the client device, notify the server device regarding the at least one value detected by the client device; and
receiving, from the client device, the notification regarding the at least one value detected by the client device.

22. The apparatus of claim 21, wherein the one or more parameters that indicate a second time window, which overlaps the first time window, in which the client device must evaluate the one or more conditions to determine whether the one or more conditions are satisfied comprise at least one of:
a parameter that indicates a maximum time the client device may wait between two adjacent evaluations of the one or more conditions made in the first time window;
a parameter that indicates a maximum time the client device may wait between two adjacent evaluations of the one or more conditions;
a parameter that indicates a minimum time the client device must wait between two adjacent evaluations of the one or more conditions made in the first time window;
a parameter that indicates a minimum time the client device must wait between two adjacent evaluations of the one or more conditions;
a parameter that indicates a maximum time from the start of the first time window the client device may wait to evaluate the one or more conditions; or
a parameter that indicates a minimum time from the start of the first time window the client device must wait to evaluate the one or more conditions.

23. The apparatus of claim 22, wherein the one or more parameters that indicate a first time window in which the client device must notify the server device regarding one or more values detected by the client device comprise at least one of:
a parameter that indicates a maximum time the client device may wait between two adjacent notifications to the server device; or
a parameter that indicates a minimum time the client device must wait between two adjacent notifications to the server device.

24. The apparatus of claim 23, wherein the one or more parameters that indicate one or more conditions that, if satisfied, the client device must notify the server device regarding the one or more values detected by the client device comprise at least one of:
one or more parameters that indicate that the client device must notify the server device if a value detected by the client device satisfies a threshold;
a parameter that indicates that the client device must notify the server device if a value detected by the client device is greater than a threshold value;
a parameter that indicates that the client device must notify the server device if a value detected by the client device is less than a threshold value; or
a parameter that indicates that the client device must notify the server device if a value detected by the client device varies a threshold amount relative to a previous value of which the client device last notified the server device.
